(19) United States
(12) Patent Application Publication
(10) Pub. No.: US 2009/0309479 A1
(43) Pub. Date: Dec. 17, 2009

(54) ELECTRON EMITTING-DEVICE AND IMAGE DISPLAY APPARATUS

(75) Inventor: Kazuya Tsujino, Hiratsuka-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/482,861

(22) Filed: Jun. 11, 2009

(30) Foreign Application Priority Data
Jun. 17, 2008 (JP) 2008-157988

(51) Int. Cl. H01J 29/70

(52) U.S. Cl. 313/413

(57) ABSTRACT

An electron emitting-device is provided that comprises a plurality of electron emission portions; and a plurality of deflection electrodes for deflecting electrons emitted from the plurality of electron emission portions, wherein each of the plurality of deflection electrodes deflect the emitted electrons toward the same deflection direction. One of the plurality of deflection electrode, which is positioned at an end of the deflection direction, less deflect the emitted electrons than other one of the plurality of deflection electrode, which is positioned at an opposite end of the deflection direction.

### BACKGROUND OF THE INVENTION

1. Field of the Invention

The present invention relates to an electron emitting-device and an image display apparatus having the electron emitting-device.

2. Description of the Related Art

Generally, in an image display apparatus having an electron emitting-device, an electron beam which has been emitted from the electron emitting-device is accelerated by an anode electrode while diverging. However, in order to realize an image display apparatus having higher definition, the image display apparatus is required to inhibit the divergence of the electron beam which has been emitted from the electron emitting-device.

A configuration having a focusing electrode provided therein is known as a configuration for inhibiting the divergence of the electron beam which has been emitted from the electron emitting-device (see Japanese Patent Application Laid-Open No. H10-199400).

### SUMMARY OF THE INVENTION

The present invention is directed at providing a configuration for inhibiting the divergence of an electron beam which has been emitted from an electron emitting-device.

The electron emitting-device according to the present invention includes: a plurality of electron emission portions; and a plurality of deflection electrodes for deflecting electrons emitted from the plurality of the electron emission portions, wherein each of the plurality of the deflection electrodes deflects the emitted electrons toward the same deflection direction, wherein one of the plurality of the deflection electrodes, which is positioned at an end of the deflection direction, less deflects the emitted electrons than other one of the plurality of the deflection electrodes, which is positioned at an opposite end of the deflection direction.

The electron emitting-device according to the present invention also includes: a plurality of electron emission portions; and a plurality of deflection electrodes for deflecting electrons emitted from the plurality of the electron emission portions, wherein each of the plurality of the deflection electrodes deflects the emitted electrons toward the same deflection direction, wherein one of the plurality of the deflection electrodes, which is positioned at an end of the deflection direction, has a shorter length in the deflection direction than other one of the plurality of the deflection electrodes, which is positioned at an opposite end of the deflection direction.

The electron emitting-device according to the present invention also includes: a plurality of electron emission portions; and a plurality of deflection electrodes for deflecting electrons emitted from the plurality of the electron emission portions, wherein each of the plurality of the deflection electrodes deflects the emitted electrons toward the same deflection direction, wherein one of the plurality of the deflection electrodes, which is positioned at an end of the deflection direction, has a larger thickness than other one of the plurality of the deflection electrodes, which is positioned at an opposite end of the deflection direction.

The electron emitting-device according to the present invention can inhibit the divergence of an electron beam which has been emitted therefrom.

Further features of the present invention will become apparent from the following description of exemplary embodiments with reference to the attached drawings.

### BRIEF DESCRIPTION OF THE DRAWINGS

FIG. 1 is a perspective view illustrating one example of a structure of an image display apparatus according to the present invention.

FIG. 2 is a schematic view illustrating a rear plate according to the present invention.

FIG. 3 is a schematic view illustrating an electron emitting-device according to a first embodiment.

FIG. 4 is a sectional view taken along the line A-A′ of FIG. 3.

FIGS. 5A and 5B are views illustrating a relationship between the length of a deflection electrode and the magnitude of the deflection of an electron.

FIGS. 6A and 6B are views illustrating an effect of a first embodiment.

FIGS. 7A, 7B and 7C are views for describing a method for manufacturing an electron emitting-device.

FIGS. 8D, 8E and 8F are views for describing a method for manufacturing an electron emitting-device.

FIGS. 9A and 9B are views illustrating a relationship between the thickness of a deflection electrode and the magnitude of the deflection of an electron.

### DESCRIPTION OF THE EMBODIMENTS

### First Embodiment

(Configuration of Image Display Apparatus)

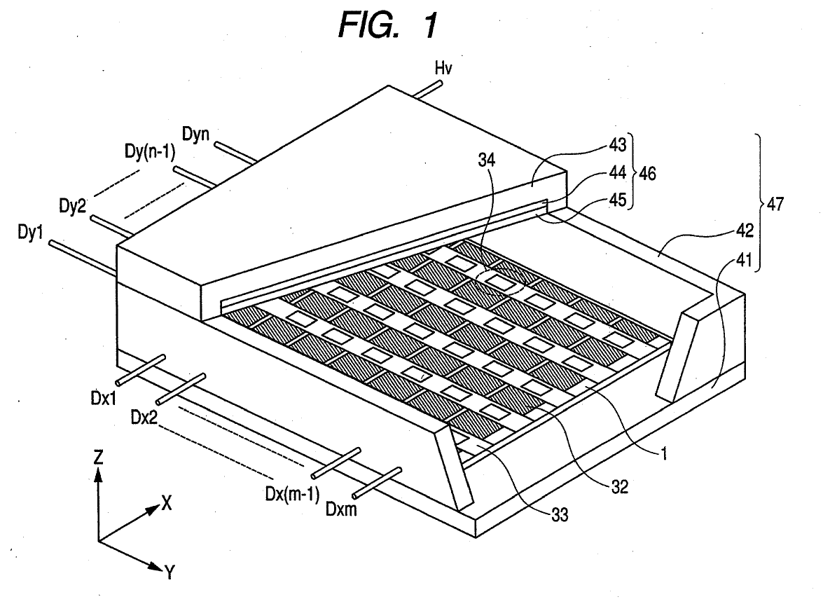

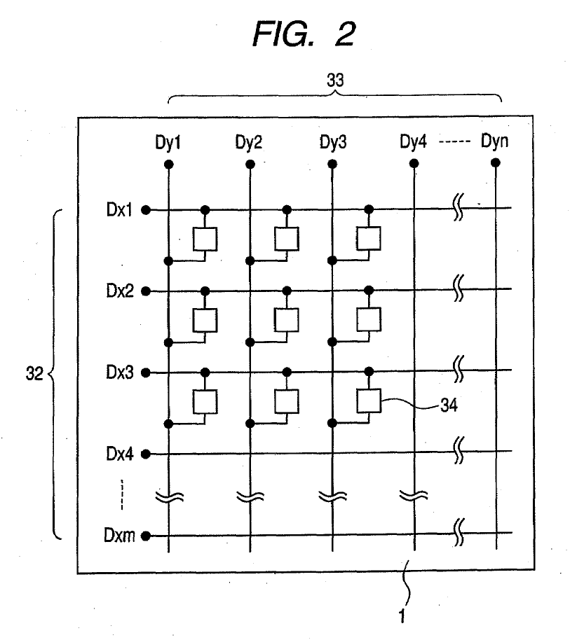

An image display apparatus having an electron emitting-device according to the present invention will now be described with reference to FIG. 1 and FIG. 2.

FIG. 1 is a perspective view illustrating one example of a structure of an image display apparatus according to the present invention, in which one part of the apparatus is cut away for illustrating the inner structure. In the figure, a substrate 1, a scan line 32, a modulation line 33, and an electron emitting-device 34 are shown, and a rear plate 41 fixes the substrate 1 thereon. A plate 46 has a phosphor 44 and a metal back 45 which works as an anode electrode, on the inner face (face in rear plate 41 side) of a glass substrate 43. A support frame 42 is shown, and an envelope 47 has the support frame 42, and the rear plate 41 and the face plate 46 which are attached to the support frame 42 through frit glass. Here, the rear plate 41 is provided mainly for the purpose of reinforcing the strength of the substrate 1, so that when the substrate 1 itself has a sufficient strength, an additional rear plate 41 is unnecessary. The image display apparatus also can have a configuration in which an unshown support member referred to as a spacer is installed in between the face plate 46 and the rear plate 41 to impart a sufficient strength against atmospheric pressure to the apparatus.

M lines of scan lines 32 are connected to terminals Dx1 and Dx2 to Dxm; and n lines of modulation lines 33 are connected to terminals Dy1 and Dy2 to Dyn (where m and n are both positive integer number). An unshown interlayer insulating layer is provided in the intersections of m lines of the scan lines 32 and n lines of the modulation lines 33, and electrically separates the both lines from each other.

A high-voltage terminal Hv is connected to the metal back 45 which works as an anode electrode, and specifies an electric potential of an anode electrode, so that an potential difference between the ground potential and the electric potential of the anode electrode becomes a DC voltage of 10 [kV], for instance. The electric potential of the anode electrode accelerates an electron emitted from the electron emitting-device toward a +Z-direction, and imparts sufficient energy for exciting the phosphor 44 to the electron.

FIG. 2 is a schematic view illustrating a rear plate according to the present invention. The rear plate of the present invention has a plurality of electron emitting-devices 34 which are connected to scan lines 32 and modulation lines 33 and are arrayed in a matrix form so as to correspond to each of a plurality of intersections between the scan lines 32 and the modulation lines 33. Each of the plurality of the electron emitting-devices 34 corresponds to one sub-pixel in an image display apparatus.

A scan circuit (unshown) is connected to the scan lines 32, and outputs a scan signal for selecting a row of electron emitting-devices 34 which are arrayed in an X-direction. A scan signal is applied to the scan line 32 by the scan circuit. On the other hand, a modulation circuit (unshown) is connected to the modulation lines 33, and outputs a modulation signal which has been modulated according to an input signal to each column of the electron emitting-devices 34 which have been arrayed in a Y-direction. A modulation signal is applied to the modulation line 33 by the modulation circuit. A driving voltage is applied to each electron emitting-device, which is a difference between the scan signal and the modulation signal. The driving voltage can be in a range of 10 V to 100 V, and can further be in a range of 10 V to 30 V.

(Configuration of Electron Emitting-Device)

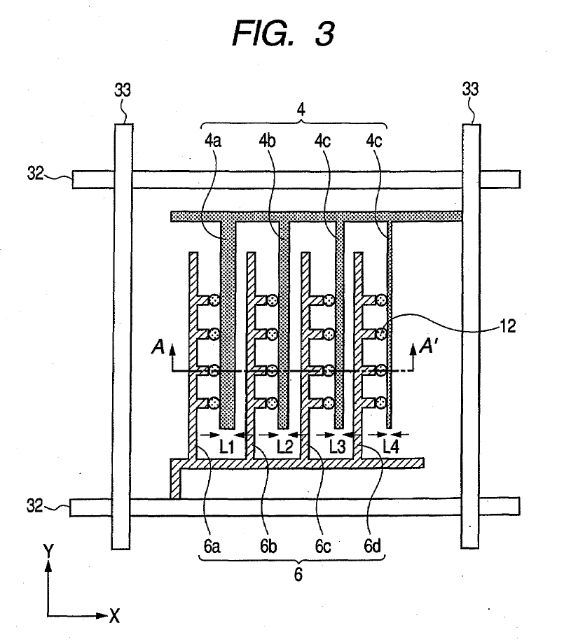

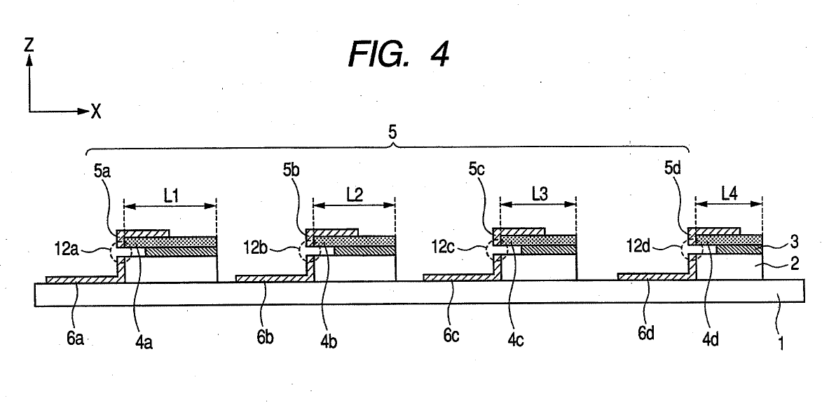

FIG. 3 is a schematic view illustrating an electron emitting-device according to the present embodiment. FIG. 4 illustrates a sectional view taken along the line A-A′ of FIG. 3. In FIG. 3, a scan line 32, a modulation line 33, a deflection electrode 4, a cathode electrode 6 and an electron emission portion 12 are shown. In FIG. 4, a substrate 1, a first insulating layer 2, a second insulating layer 3, a deflection electrode 4 (4a, 4b, 4c and 4d), a gate electrode 5, and a cathode electrode 6 (6a, 6b, 6c and 6d) are shown. A portion 12 surrounded by a dotted line is an electron emission portion.

As is illustrated in FIG. 3, the cathode electrode 6 is connected to the scan line 32. A cathodic potential based on the scan signal which has been applied to the scan line 32 is applied to the cathode electrode 6. The cathode electrode 6 has a plurality of cathode electrodes 6a, 6b, 6c and 6d as its parts. The deflection electrode 4 is connected to the modulation line 33. Furthermore, as is illustrated in FIG. 4, the deflection electrode 4 is electrically connected to the gate electrode 5. A gate potential based on the modulation signal which has been applied to the modulation line 33 is applied to the gate electrode 5 through the deflection electrode 4. The deflection electrode 4 has a plurality of deflection electrodes 4a, 4b, 4c and 4d as a plurality of its portions. Each of the deflection electrodes 4a, 4c, 4c and 4d deflects an electron which has been emitted from each of the plurality of the electron emission portions 12 toward a +X-direction (forward direction, in the figures, direction indicated by arrow of X-axis), though the detail will be described later. The deflection electrode 4d is positioned at the end in the +X-direction. The deflection electrodes 4a, 4b and 4c are positioned closer to a side of a −X-direction (direction opposite to +X-direction, in other words, backward direction of +X-direction) than the deflection electrode 4d. The deflection electrode 4a is positioned at the end of the −X-direction (direction opposite to +X-direction, in other words, backward direction of +X-direction). In the present embodiment, the deflection electrodes 4a, 4b, 4c and 4d are configured so that the respective lengths (widths) L1, L2, L3 and L4 in an X-direction are different from each other in a way of being expressed by L1>L2>L3>L4.

The electron emitting-device 34 of the present embodiment has a configuration in which the cathode electrode 6 is arranged on the side face of the insulating layer 2 and the deflection electrode 4 is provided on the insulating layer 2 through the insulating layer 3. The gate electrode 5 is connected to the deflection electrode 4. A plurality of parallel lines (four lines) in a Y-direction, each of which has the insulating layer 2, the insulating layer 3, the deflection electrode 4, the gate electrode 5 and the cathode electrode 6 that are configured as was described above, are arranged in the X-direction. Specifically, the deflection electrode 4 (and gate electrode 5) and the cathode electrode 6 are arranged in the X-direction so as to form one pair. In other words, the cathode electrode 6 and the deflection electrode 4 (and gate electrode 5) are alternately arranged in the X-direction. The electron emission portion 12 is provided in between the cathode electrode 6 and the gate electrode 5, so that it can be also said that the electron emission portion 12 and the deflection electrode 4 are alternately arranged.

The electron emitting-device 34 has a plurality of electron emission portions 12 (12a, 12b, 12c and 12d). The plurality of electron emission portions 12 (12a, 12b, 12c and 12d) are arranged (aligned) along the X-direction. Each of the plurality of the electron emission portions 12 is provided in between the cathode electrode 6 and the gate electrode 5. More specifically, the electron emitting-device 34 has the electron emission portion 12a provided in between the cathode electrode 6a and the gate electrode 5a connected to the deflection electrode 4a, and has the electron emission portion 12d provided in between the cathode electrode 6d and the gate electrode 5d connected to the deflection electrode 4d. The electron emitting-device 34 also has the electron emission portion 12b provided in between the cathode electrode 6b and the gate electrode 5b connected to the deflection electrode 4b, and has the electron emission portion 12c provided in between the cathode electrode 6c and the gate electrode 5c connected to the deflection electrode 4c.

The cathodic potential and the gate potential are applied to the electron emission portion 12 by the gate electrode 5 and the cathode electrode 6. Then, electrons are emitted from the plurality of the electron emission portions 12 according to a potential difference between the gate potential and the cathodic potential, which corresponds to the driving voltage. The gate potential has a higher potential than a cathodic potential, and has a lower potential than an anodic potential. Typically, the gate potential is controlled to be a positive potential, and the cathodic potential is controlled to be a negative potential, with respect to the ground potential.

The plurality of the electron emission portions 12 are included in the electron emitting-device 34 which corresponds to one sub-pixel. Therefore, each of portions (6a, 6b, 6c and 6d) of the cathode electrode 6 connected to each of the plurality of the electron emission portions 12 has substantially the same potential (cathodic potential). The gate electrodes 5a, 5b, 5c and 5d connected to each of the plurality of the electron emission portions 12 also have substantially the same potential (gate potential). Each of portions (4a, 4b, 4c and 4d) of the deflection electrode 4 electrically connected to the gate electrode 5 also has substantially the same potential (gate potential). Phosphors corresponding to respective colors of R, G and B provided on a face plate 46 are irradiated with electrons which have been emitted from the electron emitting-devices 34 corresponding to the phosphors of the respective colors.

Incidentally, the deflection electrode 4 in FIG. 3 has a form of having four portions in the X-direction, but has only to have two or more portions in the X-direction. For instance, the deflection electrode 4 may have a form in which the portions are only the deflection electrode 4d positioned at the end in the +X-direction and the deflection electrode 4a positioned at the end in the −X-direction, and exclude deflection electrodes 4b and 4c.

The electron emitting-device 34 in FIG. 3 also has a form of having 16 pieces of the electron emission portions 12, which are the total of four lines in the X-direction by four pieces in one line (the Y-direction), but may have two or more electron emission portions 12 in the X-direction. The electron emitting-device 34 may have one electron emission portion in one line (the Y-direction).

Next, a principle of inhibiting the divergence of an electron beam in the present embodiment will now be described. The above electron beam is a flux of a large number of electrons, which have been emitted from the electron emission portion 12.

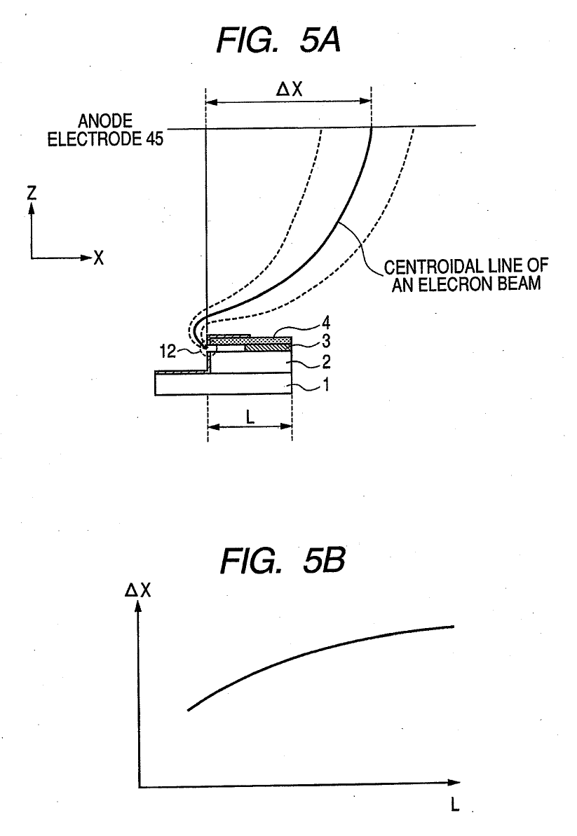

FIG. 5A is a view schematically illustrating a trajectory drawn by an electron which has been emitted from the electron emission portion 12 and has reached an anode electrode 45.

The electrons, which have been emitted from the electron emission portion 12, are deflected toward a +X-direction (in the figure, direction indicated by arrow of X-axis) by a deflection electrode 4. The +X-direction corresponds to a “deflection direction” of the present invention. The “deflection direction” of the present invention is a direction in an XY plane which is a plane parallel to the principal face of a substrate 1 or to the principal face of the anode electrode, and in which the spread of the electron beam (divergence) becomes a problem. Here, the deflection toward the +X-direction is taken as an example. Here, popularly, there are two cases for the meaning of the term “direction”. One means either forward direction or backward direction (e.g. +X-direction or −X-direction). And the other means both of the forward direction and the backward direction (e.g. X-direction include both +X-direction and −X-direction). However, in the present invention, the “deflection direction” means one direction toward which the electrons are deflected (in this case, +X-direction).

The electron beam which has been emitted from the electron emission portion 12 reaches the anode electrode 45 while diverging in the X-direction as is shown by a dotted line of FIG. 5A. The centroidal line of an electron beam shown by a solid line of FIG. 5A is not a geometric center of gravity obtained from only the shape of the electron beam, but the center of gravity obtained from the distribution weighted of the electron density in the shape of the electron beam. A magnitude of deflection shall be defined by a distance AX in the X-direction from the position at which the electrons have been emitted to the centroidal line of the electron beam on the anode electrode.

FIG. 5B is a graph illustrating a relationship between the length (L) of a deflection electrode 4 in a +X-direction and the magnitude of deflection AX. This graph is obtained by a simulation technique.

As is clear from FIG. 5B, the longer the length (L) is, the larger the magnitude of deflection AX is. This is because the electrons which have been emitted from an electron emission portion 12 are deflected to a +X-direction by a higher electric potential (substantially same electric potential as gate potential) than a cathodic potential, which has been applied to the deflection electrode 4, and accordingly because the electrons are more largely deflected as the length of the deflection electrode 4 in the X-direction increases.

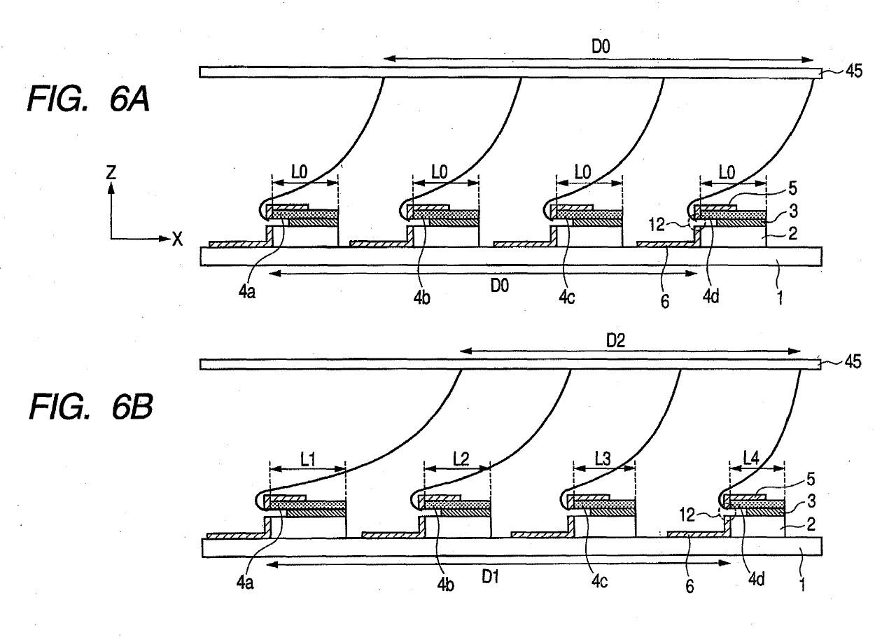

An effect of the present embodiment will now be described with reference to FIGS. 6A and 6B.

FIG. 6A is a view illustrating deflection electrodes 4a, 4b, 4c and 4d which have the same lengths of L0 in an X-direction, so as to be compared with the present embodiment. In this case, the electrons are deflected by the equal magnitude due to respective deflection electrodes. Here, a distance between an electron emission portion corresponding to the deflection electrode 4d which is positioned at the end in a +X-direction and an electron emission portion corresponding to the deflection electrode 4a which is positioned at the end in a −X-direction (opposite direction of +X-direction or backward direction of +X-direction) shall be represented by D0. Then, a distance between the centroidal line of the electron beam which has been emitted from the electron emission portion corresponding to the deflection electrode 4d and the centroidal line of the electron beam which has been emitted from the electron emission portion corresponding to the deflection electrode 4a also results in D0. Therefore, in this case, the electron emitting-device cannot sufficiently inhibit the divergence of the electron beam which has been emitted from the electron emitting-device.

In contrast to this, in the present embodiment, the plurality of the deflection electrodes 4a, 4b, 4c and 4d for deflecting electrons which have been emitted from an electron emission portions 12 toward the same direction (+X-direction) are arranged as are illustrated in FIG. 6B. Specifically, the deflection electrode 4d among the plurality of the deflection electrodes, which is positioned at the end in the +X-direction toward which the electrons are deflected, is arranged so as to have a shorter length L4 in the X-direction than the length L1 in the X-direction of the deflection electrode 4a that is positioned at the end in the −X-direction (opposite direction of +X-direction or backward direction of +X-direction). Here, a distance between the electron emission portion corresponding to the deflection electrode 4d, which is positioned at the end in the +X-direction, and the electron emission portion corresponding to the deflection electrode 4a, which is positioned at the end in an opposite direction in the +X-direction, shall be represented by D1. Then, a distance between the centroidal line of an electron beam which has been emitted from the electron emission portion corresponding to the deflection electrode 4d and the centroidal line of an electron beam which has been emitted from the electron emission portion corresponding to the deflection electrode 4a results in D2 (D1>D2). Therefore, the electron emitting-device can inhibit the divergence of the electron beam which has been emitted from the electron emitting-device.

The spread (degree of divergence) of the electron beam which reaches the anode electrode largely depends on the magnitude of deflections of the electrons which have been emitted from the electron emission portions positioned at both ends in the X-direction, so that the lengths L2 and L3 in the X-direction of the deflection electrodes 4b and 4c other than those in the both ends give a less influence to the spread of the electron beam. However, in order to make the distribution of the electron density in the electron beam which reaches the anode electrode more uniform, the lengths in the X-direction of the plurality of the deflection electrodes 4a, 4b, 4c and 4d can be monotonically decreased (L1>L2>L3>L4, and L1>L4).

(Method for Manufacturing Electron Emitting-Device)

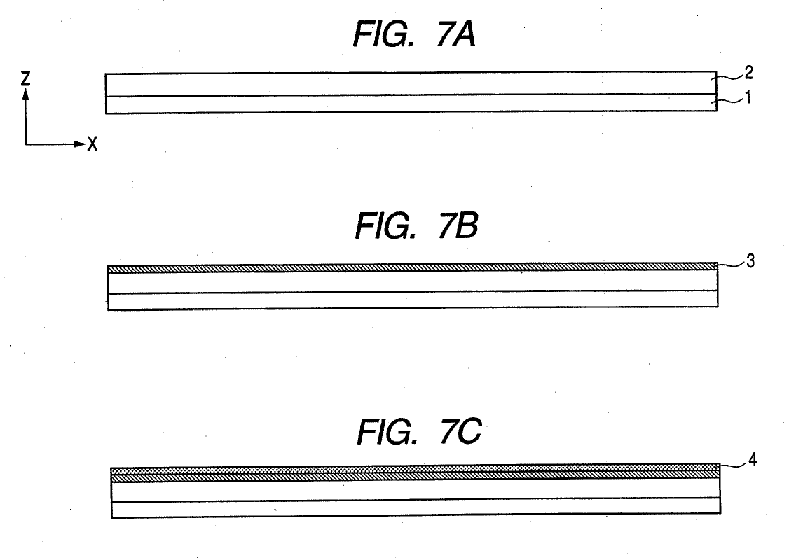

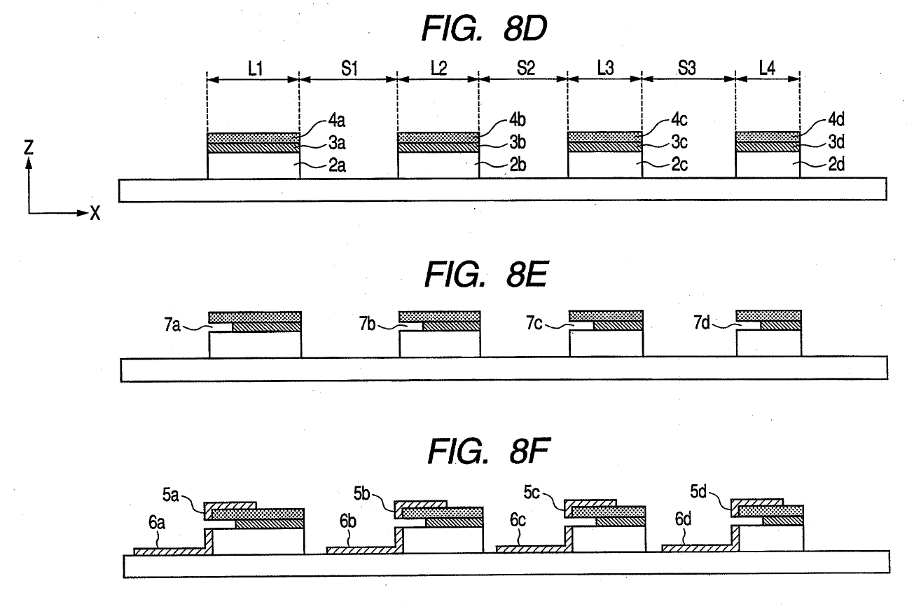

Next, a method for manufacturing an electron emitting-device according to the present embodiment will now be described with reference to FIGS. 7A, 7B and 7C, and FIGS. 8D, 8E and 8F.

A substrate 1 is an insulative substrate for mechanically supporting a device. For instance, the insulative substrate can employ a quartz glass, a glass containing a reduced amount of impurities such as Na, a soda-lime glass plate and a silicon substrate. The substrate 1 can have not only a high mechanical strength but also resistances to a dry etching process, a wet etching process, an alkaline solution like a liquid developer, and an acid solution, as necessary functions. When being used as an integrated product like a display panel, the substrate 1 can also have a small difference of thermal expansion between itself and a film-forming material or another member to be stacked thereon. The substrate 1 can also be a material through which an alkali element and the like hardly diffuse from the inner portion of the glass due to heat treatment.

An insulating layer 2 is stacked on the substrate 1, as is illustrated in FIG. 7A. The insulating layer 2 is an insulative film made from a material having excellent workability; is silicon nitride or silicon oxide, for instance; and is formed with a general vacuum film-forming method such as a sputtering method, a CVD method and a vapor deposition method.

Next, an insulating layer 3 is formed on the insulating layer 2 with a general vacuum film-forming method such as a sputtering method, a CVD method and a vapor deposition method, as is illustrated in FIG. 7B.

Thicknesses of the insulating layers 2 and 3 are each set in a range between 5 nm and 50 μm, and can be selected from a range between 50 nm and 500 nm. Materials for the insulating layer 2 and insulating layer 3 can be selected so as to have a different etching speed from each other when being etched. The ratio of the etching speed of the insulating layer 2 to the insulating layer 3 can be 10 or more, and can further be 50 or more. For instance, Si₃N₄ can be used for the insulating layer 2, and an insulative material such as SiO₂, a PSG film having a high phosphorus concentration or a BSG film having a high boron concentration can be used for the insulating layer 3.

An electroconductive layer 4 is formed on the insulating layer 3, as is illustrated in FIG. 7C. This electroconductive layer 4 shall be a deflection electrode 4 later.

The electroconductive layer 4 is formed with a general vacuum film-forming technology such as a vapor deposition method and a sputtering method. A material to be used for the electroconductive layer 4 can have high thermal conductivity in addition to electroconductivity and can have a high melting point. The material includes, for instance: a metal such as Be, Mg, Ti, Zr, Hf, V, Nb, Ta, Mo, W, Al, Cu, Ni, Cr, Au, Pt and Pd, or an alloy material thereof; and a carbide such as TiC, ZrC, HfC, TaC, SiC and WC. The materials also include: a boride such as HfB₂, ZrB₂, CeB₆, YB₄ and GdB₄; a nitride such as TiN, ZrN, HfN and TaN; a semiconductor such as Si and Ge; and an organic polymer material. The material further includes amorphous carbon, graphite, diamond like carbon, carbon having diamond dispersed therein, and a carbon compound. The material is appropriately selected from the above materials.

The thickness of the electroconductive layer 4 is set in a range of 5 nm to 500 nm, and can be selected from the range of 50 nm to 500 nm.

Subsequently, a resist pattern is formed on the electroconductive layer 4 with a photolithographic technology, and then the electroconductive layer 4, the insulating layer 3 and the insulating layer 2 are sequentially processed with an etching technique, as is illustrated in FIG. 8D. Thereby, the deflection electrodes 4a, 4b, 4c and 4d, the insulating layers 3a, 3b, 3c and 3d and the insulating layers 2a, 2b, 2c and 2d can be obtained.

A method to be generally employed for such an etching process is an RIE (Reactive Ion Etching) which can precisely etch a material by irradiating the material with a plasma that has been formed through the conversion of an etching gas. A processing gas to be selected at this time is a fluorine-based gas such as CF₄, CHF₃ and SF₆, when an objective member to be processed forms a fluoride. When the objective member forms a chloride as Si and AL do, a chloride-based gas such as Cl₂ and BCl₃ is selected. In order to impart a selection ratio to the above layers with respect to a resist, to surely acquire the smoothness of an etched face, or to increase an etching speed, gaseous hydrogen, oxygen, argon or the like is added whenever necessary. This etching process may be stopped right before the top face of the substrate 1 is etched, or one part of the substrate 1 may be etched.

An arrangement number (n) of the deflection electrodes arranged in an X-direction, a length (L) (L1 to L4) in the X-direction of each of the deflection electrodes and a space (S) (S1 to S3) between adjacent devices can be appropriately changed. The length (L) can be controlled in a range of several micrometers to several tens of micrometers.

Subsequently, only a side face of the insulating layer 3 is partially removed on one side face of the stacked body by using an etching technique, and recess 7 (7a, 7b, 7c and 7d) are formed as is illustrated in FIG. 8E.

A mixture solution of ammonium fluoride and hydrofluoric acid, which is referred to as a buffer hydrofluoric acid (BHF), can be used for the etching technique when the insulating layer 3 is a material formed from SiO₂, for example. When the insulating layer 3 is a material formed from silicon nitride, the insulating layer 3 can be etched with the use of a phosphoric-acid-based hot etching solution.

The depth of the recess 7 is specifically a distance between the side face of the insulating layer 3 and the insulating layer 2, in the recess 7; and can be formed so as to be approximately 30 nm to 200 nm.

Incidentally, the present embodiment showed a form in which the insulating layer 2 and the insulating layer 3 are stacked, but the present invention is not limited to the form. The recess 7 may be formed by removing a part of one insulating layer.

Subsequently, the electroconductive material is deposited on the substrate 1 and the side face of the insulating layer 3, as is illustrated in FIG. 8F. At this time, the electroconductive material is also deposited on the deflection electrode 4.

The electroconductive material may be a material which has electroconductivity and emits an electric field, and generally can be a material which has a high melting point of 2,000° C. or higher, has a work function of 5 eV or less, and hardly forms a chemical reaction layer thereon such as an oxide or can easily remove the chemical reaction layer therefrom. Such materials include: a metal such as Hf, V, Nb, Ta, Mo, W, Au, Pt and Pd or an alloy material thereof; a carbide such as TiC, ZrC, HfC, TaC, SiC and WC; and a boride such as HfB2, ZrB2, CeB6, YB4 and GdB4. Such materials also include: a nitride such as TiN, ZrN, HfN and TaN; and amorphous carbon, graphite, diamond like carbon, carbon having diamond dispersed therein and a carbon compound.

A method to be employed for depositing the electroconductive material is a general vacuum film-forming technology such as a vapor deposition method and a sputtering method, and can be an EB vapor deposition method.

In the present embodiment, a deflection electrode 4 and a gate electrode 5 were described to be different members, but the deflection electrode 4 and the gate electrode 5 do not necessarily need to be the different members. For instance, the gate electrode 5 may be directly connected to a modulation line 33, and the gate electrode 5 itself may function as the deflection electrode as well. In this case, the lengths of the gate electrodes 5 to be used in place of the deflection electrodes 4a, 4b, 4c and 4d may be different in the X-direction. Alternatively, the gate electrode 5 may be eliminated, and the deflection electrode 4 may function as a gate electrode as well. The deflection electrode 4 was also described to be a different member which was disposed on a second insulating layer 3, but the deflection electrode 4 may be disposed on a substrate 1 and connected to the gate electrode 5 (or modulation line 33).

The structure of the electron emitting-device which can be applied to the present invention is not limited to the form described herein. The electron emitting-device can adopt an arbitrary configuration such as an electron emission type of a Spindt type or the like, an MIM type and a surface conduction type as the configuration of the electron emission portion, as long as the electron emitting-device has a plurality of deflection electrodes for deflecting electrons emitted from the plurality of the electron emission portions toward the same deflection direction. The electron emitting-device may also adopt a configuration in which one portion of at least one of the gate electrode 5 and a cathode electrode 6 constitutes one portion of an electron emission portion 12.

### Second Embodiment

In the description of First embodiment, a configuration of making lengths of the deflection electrodes different from each other in an X-direction was used in order to make deflected magnitudes of electrons by deflection electrodes different from each other, but the present invention is not limited to such a configuration.

In other words, the divergence of an electron beam can be inhibited by a configuration in which a deflection electrode 4d positioned at an end of a direction (deflection direction) toward which electrons, are deflected less deflects the emitted electrons than other one of a deflection electrode 4a positioned at the end in the opposite direction to the deflection direction.

For instance, the electron emitting-device can vary the deflected magnitude of the electrons due to the deflection electrode by varying the thickness of the deflection electrode 4. More specifically, the divergence of an electron beam can be inhibited by making the deflection electrode 4d to be thicker than the deflection electrode 4a, in the electron emitting-device shown in First embodiment.

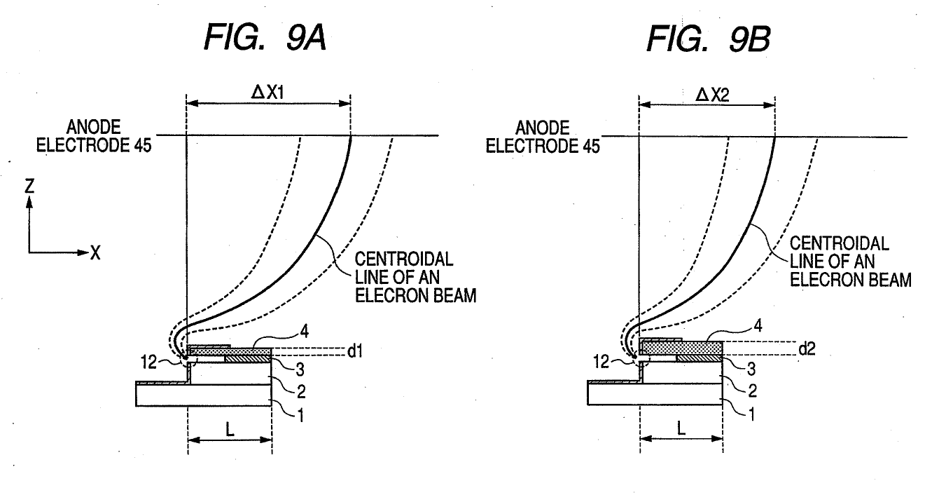

FIGS. 9A and 9B are views illustrating a relationship between the thickness (d) of a deflection electrode 4 and the magnitude of the deflection ΔX of an electron.

FIG. 9A is a view illustrating that the magnitude of the deflection is ΔX1 when the thickness of a deflection electrode 4 is d1. FIG. 9B is a view illustrating that the magnitude of the deflection is ΔX2 (ΔX2<ΔX1) when the thickness of the deflection electrode 4 is d2 (d1<d2). It is understood that as the thickness (d) of the deflection electrode 4 increases, the deflection ΔX decreases.

As is understood when FIG. 9A is compared with FIG. 9B, the above result comes from such a phenomenon that when the thickness (d) of the deflection electrode 4 increases, the state of an electric field in the vicinity of an electron emission portion changes to make the electrons hardly deflected.

In order to make the distribution of the electron density in an electron beam which reaches an anode electrode more uniform, the thicknesses of a plurality of deflection electrodes 4a, 4b, 4c and 4d can monotonically increase.

In order to make the thickness (d) of the deflection electrodes 4 different from others in this way, a process may be employed which includes the steps of: forming an electroconductive layer 4 illustrated in FIG. 7C; subsequently forming such a pattern that a resist covers parts except a part at which the thickness of the deflection electrode will be increased; and then additionally depositing an electroconductive layer on the pattern.

A configuration, for instance, of making the shape of the deflection electrodes 4 different from each other can also be adopted as another form of changing the deflected magnitude of the electrons by the deflection electrode.

For instance, a configuration can be applied to the present invention, in which the deflection electrode 4d positioned at the end in an X-direction has such a shape as to less deflect the electrons than other deflection electrodes.

### Exemplary Embodiment 1

More specific exemplary embodiments of the present invention will now be described below with reference to FIGS. 7A, 7B and 7C, and FIGS. 8D, 8E and 8F.

(Step 1)

A sod-lime glass plate was used for a substrate 1, and was sufficiently cleaned. Then, an Si₃N₄ film was deposited thereon as an insulating layer 2 with a sputtering method so as to have the thickness of 500 nm (FIG. 7A).

(Step 2)

Subsequently, SiO₂ was deposited thereon as an insulating layer 3 with a sputtering method so as to have the thickness of 20 nm (FIG. 7B). Then, TaN was deposited thereon as an electroconductive layer 4 so as to have the thickness of 20 nm (FIG. 7C).

(Step 3)

Subsequently, a positive photoresist was formed thereon with a spin coating method. Then, a photomask pattern was exposed and developed to form a resist pattern. At this time, the resist pattern was formed so that L1 was 12 μm, L2 was 10 μm, L3 was 8 μm, L4 was 6 μm, and S1, S2 and S3 were 10 um. Then, the insulating layer 2, the insulating layer 3 and the electroconductive layer 4 were dry-etched with the use of a CF4 gas while the patterned photoresist was used as a mask. The dry etching operation was stopped right before the substrate 1 was etched, and a step structure was formed (FIG. 8D).

(Step 4)

The insulating layers 3a to 3d were selectively etched by etching the formed step portion for 11 minutes while using a buffer hydrofluoric acid (BHF) (LAL100/made by STELLA CHEMIFA CORPORATION) as an etchant. Recesses 7a to 7d were formed by etching the insulating layers 3a to 3d up to approximately 60 nm deep from the side wall of the step (FIG. 8E).

(Step 5)

Subsequently, Mo was selectively deposited thereon from a diagonally 45 degrees upper part with a diagonal deposition method to form gate electrodes 5a to 5d and cathode electrodes 6a to 6d with the thicknesses of 10 nm (FIG. 8F).

A distance between a face plate and a rear plate was set at 1.6 mm, and an anode voltage was set at 12 kV. In the present exemplary embodiment, D1 in FIG. 6B resulted in 60 μm. At this time, D2 in FIG. 6B resulted in 46 μm. According to the present exemplary embodiment, the size D2 of the electron beams determined from the positions of the centroidal lines of the electron beams on the face plate was made to be smaller than the size D1 of the electron emission portions on the rear plate. In other words, the divergence of the electron beam was inhibited.

### COMPARATIVE EXAMPLE 1

In the present comparative example, only Step 3 is different from that in Exemplary embodiment 1. Other steps are the same as in Exemplary embodiment 1.

(Step 3)

Subsequently, a positive photoresist was formed with a spin coating method. Then, a photomask pattern was exposed and developed to form a resist pattern. At this time, the resist pattern was formed so that L1, L2, L3 and L4 were 10 μm and S1, S2, S3 and S4 were 10 μm. Then, the insulating layer 2, the insulating layer 3 and the electroconductive layer 4 were dry-etched with the use of a CF4 gas while the patterned photoresist was used as a mask. The dry etching operation was stopped right before the substrate 1 was etched, and a step structure was formed (FIG. 8D).

In the present comparative example, both D0 in a rear plate side and D0 in a face plate side in FIG. 6A resulted in 60 μm, and the divergence of the electrons could not be sufficiently inhibited.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-157988, filed Jun. 17, 2008, which is hereby incorporated by reference herein in its entirety.

What is claimed is:

1. An electron emitting-device, comprising:
a plurality of electron emission portions; and
a plurality of deflection electrodes for deflecting electrons emitted from the plurality of electron emission portions,
wherein each of the plurality of deflection electrodes deflect the emitted electrons toward the same deflection direction, and each of the plurality of deflection electrodes is arranged along the deflection direction,
wherein one of the plurality of deflection electrode, which is positioned at an end of the deflection direction, less deflect the emitted electrons than other one of the plurality of deflection electrode, which is positioned at an opposite end of the deflection direction.

2. The electron emitting-device according to claim 1, comprising:
a plurality of cathode electrode;
wherein the plurality of electron emission portions emit electrons by setting an electric potential of the plurality of deflection electrode to be higher than an electric potential of the plurality of cathode electrodes.

3. The electron emitting-device according to claim 2, wherein the plurality of deflection electrodes and the plurality of cathode electrode are alternately arranged along the deflection direction.

4. The electron emitting-device according to claim 1, wherein a magnitude of the deflection of the electrons to the deflection direction exhibited by each of the plurality of deflection electrodes monotonically decreases along the deflection direction.

5. An electron emitting-device, comprising:
a plurality of electron emission portions; and
a plurality of deflection electrodes for deflecting electrons emitted from the plurality of electron emission portions,
wherein each of the plurality of deflection electrodes deflect the emitted electrons toward the same deflection direction, and each of the plurality of deflection electrodes is arranged along the deflection direction, and
wherein one of the plurality of deflection electrode, which is positioned at an end of the deflection direction, has a shorter length in the deflection direction than other one of the plurality of the deflection electrode, which is positioned at an opposite end of the deflection direction.

6. The electron emitting-device according to claim 5, comprising:
a plurality of cathode electrode;
wherein the plurality of electron emission portions emit electrons by setting an electric potential of the plurality of deflection electrode to be higher than an electric potential of the plurality of cathode electrodes.

7. The electron emitting-device according to claim 6, wherein each of the plurality of deflection electrodes and each of the plurality of cathode electrode are alternately arranged along the deflection direction.

8. The electron emitting-device according to claim 5, comprising:
a plurality of gate electrodes and a plurality of cathode electrodes;
wherein the plurality of the electron emission portions is provided between each of the plurality of the gate electrodes and each of the cathode electrodes, and the plurality of electron emission portions emit electrons by applying a voltage between each of the plurality of deflection electrode and each of the plurality of cathode electrode,
wherein the voltage is to be applied so that an electric potential of the plurality of gate electrodes is to be higher than an electric potential of the plurality of cathode electrodes, and
wherein each of the plurality of deflection electrodes is electrically connected to each of the plurality of gate electrodes.

9. The electron emitting-device according to claim 8, wherein each of the plurality of deflection electrodes and each of the plurality of cathode electrode are alternately arranged along the deflection direction.

10. The electron emitting-device according to claim 5, wherein the length in the deflection direction of the plurality of deflection electrodes monotonically decreases along the deflection direction.

11. An electron emitting-device, comprising:
a plurality of electron emission portions; and
a plurality of deflection electrodes for deflecting electrons emitted from the plurality of electron emission portions
wherein, each of the plurality of deflection electrodes deflecting the emitted electrons toward the same deflection direction, and each of the plurality of the deflection electrodes arranged along the deflection direction,
wherein one of the plurality of the deflection electrode, which is positioned at an end of the deflection direction, has less thickness than the other one of the plurality of the deflection electrode, which is positioned at an opposite end of the deflection direction.

12. The electron emitting-device according to claim 11, comprising:
a plurality of gate electrodes and a plurality of cathode electrodes;
wherein the plurality of the electron emission portions is provided between each of the plurality of the gate electrodes and each of the cathode electrodes,
wherein the plurality of electron emission portions emit electrons by applying a voltage between each of the plurality of deflection electrode and each of the plurality of cathode electrode,
wherein the voltage is to be applied so that an electric potential of the plurality of gate electrodes is to be higher than an electric potential of the plurality of cathode electrodes, and
wherein each of the plurality of deflection electrodes is electrically connected to each of the plurality of gate electrodes.

13. The electron emitting-device according to claim 12, wherein each of the plurality of deflection electrodes and each of the plurality of cathode electrode are alternately arranged along the deflection direction.

14. The electron emitting-device according to claim 11, wherein the thickness of the plurality of deflection electrodes monotonically decreases along the deflection direction.

15. An image display apparatus, comprising:
a rear plate having a plurality of electron emitting-devices connected to a plurality of scan wirings and a plurality of modulation wirings and arrayed in a matrix; and
a face plate having an anode electrode for accelerating electrons emitted from the electron emitting-devices,
wherein the electron emitting-device is the electron emitting-device according to claim 1.

16. An image display apparatus, comprising:
a rear plate having a plurality of electron emitting-devices connected to a plurality of scan wirings and a plurality of modulation wirings and arrayed in a matrix; and
a face plate having an anode electrode for accelerating electrons emitted from the electron emitting-devices,
wherein the electron emitting-device is the electron emitting-device according to claim 5

17. An image display apparatus, comprising:
a rear plate having a plurality of electron emitting-devices connected to a plurality of scan wirings and a plurality of modulation wirings and arrayed in a matrix; and
a face plate having an anode electrode for accelerating electrons emitted from the electron emitting-devices,
wherein the electron emitting-device is the electron emitting-device according to claim 11.
